(19) United States
(12) Patent Application Publication
(10) Pub. No.: US 2005/0041844 A1
(43) Pub. Date: Feb. 24, 2005

(54) Diagnosis aid apparatus

(75) Inventor: Kenji Yamanaka, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 10/918,527

(22) Filed: Aug. 13, 2004

(30) Foreign Application Priority Data
Aug. 22, 2003 (JP) 2003-298792

(51) Int. Cl. G06K 9/00

(52) U.S. Cl. 382/128

(57) ABSTRACT

A diagnosis aid apparatus includes: a display section for displaying a medical image of a photographed subject; an abnormal shadow candidate detecting section for detecting an abnormal shadow candidate from the medical image based on a detection condition; a detection performance inspecting section for inspecting a detection performance in each detection condition of the abnormal shadow candidate by comparing a detection result of the abnormal shadow candidate detected by the abnormal shadow candidate detecting section with accompanying information of the medical image; and a data outputting section for displaying the detection performance of the abnormal shadow candidate, which is inspected by the detection performance inspecting section, on the display section.

### BACKGROUND OF THE INVENTION

1. Field of the Invention

The invention relates to diagnosis aid apparatus which detects the abnormal shadow candidate by making image analysis of a medical image.

2. Description of Related Art

In a medical field, digitalization of a medical image which is generated by photographing a subject is realized. At a diagnosis, a medical image data generated by CR (Computed Radiography), CT (Computed Tomography), MRI (Magnetic Resonance Imaging), US (Ultrasound System) and the like, is displayed on a monitor and subsequently, a doctor interprets the medical image displayed on the monitor and observes condition and change of lesion.

According to an earlier development, for the purpose of reducing load on a doctor, medical image processing apparatus called Computed-Aided Diagnosis (hereinafter, referred to as a CAD) which detects lesion as the abnormal shadow candidate automatically is developed. This detection processing of the abnormal shadow candidate is a processing which detects the abnormal shadow candidate considered to be the abnormal shadow of mass and a cluster of microcalcifications (hereinafter collectively referred to as the abnormal shadow) using a computer.

Further, in the abnormal shadow detection processing system, such techniques that evaluate quantitatively a detection performance of CAD using a corrected result based on both of a detection result of the abnormal shadow candidate and a result judged by a doctor, a diagnosis accuracy of the image by a doctor using a calculated detection rate of cancer based on both of a result of interpretation of medical image diagnosis and a result of pathology diagnosis, are developed (for example, JP-Tokukai-2000-276587A). In such abnormal shadow detection processing system, this result can be used for improvement in interpretation of medical image by checking diagnostic accuracy, a detection rate of cancer and the like.

However, in the above-described abnormal shadow processing system, by relating the results of detection processing about a plurality of image information to corrected result after correcting the result, storing and testing them by comparison, an accuracy of detection executed by automatic detection processing is only obtained by statistics processing. Further, based on this result, the change in a detection algorithm, adjustment of a layout and the like which is carried out when the abnormal shadow and an original image, are output in combination with them, is depended on each doctor.

Therefore, each doctor can change algorithm and adjust various kinds of setup parameters respectively, based on a diagnosis accuracy, detection rate of cancer and the like which they have experienced. However, these operation are troublesome, and judgment of the algorithm and setup for improving the diagnostic accuracy and the detection rate of cancer and the like, as a whole, not individual, are difficult.

### SUMMARY OF THE INVENTION

An object of the present invention is to provide diagnosis aid apparatus for easily enabling adjustment of a detection performance of the abnormal shadow candidate according to doctor's skill, and for trying to level up interpretation of medical image and improving diagnosis efficiency by showing a doctor information used as index when the detection performance of the abnormal shadow candidate is adjusted.

In order to solve the above problems, in accordance with a first aspect of the invention,
a diagnosis aid apparatus comprises:
a display section for displaying a medical image of a photographed subject;
an abnormal shadow candidate detecting section for detecting an abnormal shadow candidate from the medical image based on a detection condition;
a detection performance inspecting section for inspecting a detection performance in each detection condition of the abnormal shadow candidate by comparing a detection result of the abnormal shadow candidate detected by the abnormal shadow candidate detecting section with accompanying information of the medical image;
a data outputting section for displaying the detection performance of the abnormal shadow candidate, which is inspected by the detection performance inspecting section, on the display section.

Preferably, the apparatus further comprises: a specifying section for specifying a plurality of medical images in which the abnormal shadow candidate detecting section detects the abnormal shadow candidate.

Preferably, the abnormal shadow candidate detecting section sets up at least two or more selected among a plurality of combinations of algorithms and external parameters or among a plurality of combinations of one algorithm and external parameters or among a plurality of combinations of algorithms and one external parameter as the detection condition of the abnormal shadow candidate, and
the apparatus further comprises a data storing section for storing the algorithm and the external parameters set up by the abnormal shadow candidate detecting section so as to relate the algorithm and the external parameter to the medical image.

Preferably, the abnormal shadow candidate detecting section applies the at least two or more of set up selected among the plurality of combinations of algorithms and external parameters or among the plurality of combinations of one algorithm and external parameters or among the plurality of combinations of algorithms and one external parameter among the algorithms or external parameters, based on pattern of the plurality of combinations of algorithms and external parameters or the plurality of combinations of one algorithm and external parameters or the plurality of combinations of algorithms and one external parameter and detects the abnormal shadow candidate from the medical image; and
the data storing section stores the detection result of the abnormal shadow candidate detected by the abnormal shadow candidate detecting section so as to relate the detection result of the abnormal shadow candidate detected by the abnormal shadow candidate detecting section to the algorithms or the external parameters being the detection condition.

Preferably, the apparatus further comprises a data outputting section for displaying progress in the detection of the abnormal shadow candidate on the display section while the detection of the abnormal shadow candidate is performed by the abnormal shadow candidate detecting section.

Preferably, the data outputting section displays at least one or more of patient information, information of examination, medical image information, the algorithm, and the external parameter about the medical image in which detection of the abnormal shadow candidate is performed when the progress is displayed on the display section.

Preferably, the data storing section stores at least one of a diagnostic result, a pathological diagnostic result, and a confirmed diagnostic result by a doctor for an interpretation of a medical image as the accompanying information of the medical image so as to relate the medical image.

Preferably, the medical image includes at least one of the diagnostic result, the pathological diagnostic result, and the confirmed diagnostic result by the doctor for the interpretation of the medical image.

Preferably, the detection performance inspecting section judges truth or false about the detection result in each detected abnormal shadow candidate based on the accompanying information of the medical image and the detection result of the abnormal shadow candidate, and
the data storing section stores a judged result with the medical image.

Preferably, the detection performance inspecting section calculates statistics in each of the applied algorithm, the applied external parameter, or the combination of the applied algorithm and the applied external parameter as a result of inspection for the detection performance based on the judged result stored in the data storing section, and based on the calculated statistics, and creates a graph showing a rate of truth or false about the detected abnormal shadow candidate; and
the data outputting section displays the graph created by the detection performance inspecting section on the display section.

Preferably, the detection performance inspecting section calculates the statistics in each of the applied algorithm, the applied external parameter or the combination of the applied algorithm and the applied external parameter as the result of inspection for the detection performance based on the judged result stored in the data storing section, and creates the simulation image which shows the rate of truth or false about the detected abnormal shadow candidate; and
the data outputting section displays the simulation image created by the detection performance inspecting section on the display section.

Preferably, the data outputting section prints out at least one of numerical information about the statistics calculated as the result of the inspection, the graph, and a simulation image with the medical image.

Preferably, the medical image is a mammogram.

Preferably, the medical image is the medical image generated by a CT apparatus or an MRI apparatus.

Preferably, the medical image is a medical image generated by an ultrasound system.

According to the invention, when the detection performance of the abnormal shadow candidate is adjusted in the diagnosis aid apparatus for detecting the abnormal shadow candidate from medical image, by displaying the detection performance of the abnormal shadow candidate obtained from the past detection result of the abnormal shadow candidate and by regarding the displayed detection performance as index, suitable adjustments of the detection performance corresponding to doctor's skill can be performed more easily.

### BRIEF DESCRIPTION OF THE DRAWINGS

The present invention will become more fully understood from the detailed description shown hereinafter and the accompanying drawing, and thus are not intended as a definition of the limits of the present invention, and wherein:

FIG. 1 is a block diagram showing a functional configuration of a diagnosis aid apparatus 10 in the embodiment to which the invention is applied;

FIG. 2 is a view showing one example of TP-FP graph created by a detection performance inspecting section shown in FIG. 1;

FIG. 3 is a view showing one example of simulation image created by the detection performance inspecting section shown in FIG. 1;

FIG. 4 is a flowchart showing abnormal shadow candidate detection processing performed by the diagnosis aid apparatus 10;

FIG. 5 is a view showing one example of display screen for progress of medical image processing displayed on a display section of FIG. 1;

FIG. 6A is a view showing one example of the display screen for medical image containing progress displayed on the display section of FIG. 1;

FIG. 6B is a view showing an example of data structure of information about the medical image in which the abnormal shadow candidate detection is performed;

FIGS. 7A to 7C are views showing one example of the display screen for medical image containing TP-FP graph displayed on the display section of FIG. 1;

FIG. 8A is a view showing one example of the display screen for medical image containing the simulation image displayed on the display section of FIG. 1;

FIG. 8B is an enlarged diagram showing one example of the simulation image shown in FIG. 8A;

FIG. 8C is an enlarged diagram showing one example of the simulation image shown in FIG. 8A;

FIG. 9 is a flowchart showing a detection performance adjustment processing performed by the diagnosis aid apparatus 10;

FIG. 10A is a view illustrating result of inspection for detection performance stored in a data storing section; and

FIG. 10B is a view showing one example of TP-FP graph displayed on a display section 22 in the adjustment processing of detection performance.

### PREFERRED EMBODIMENTS OF THE INVENTION

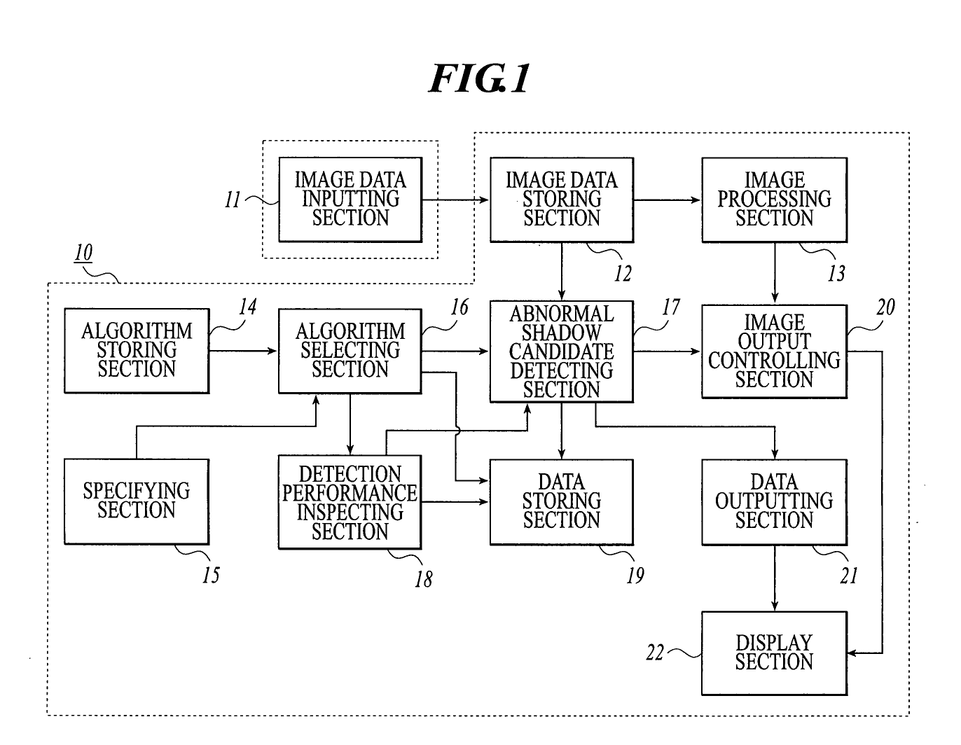

Hereinafter, embodiments of the invention will be explained in detail with reference to FIG. 1 to FIG. 8C, and thus scope of the invention is not limited to the example of illustration.

First, configuration of the embodiments will be explained.

FIG. 1 is a view showing functional configuration of the diagnosis aid apparatus 10 in the present embodiments. As shown in FIG. 1, the diagnosis aid apparatus 10 connected to a image data inputting section 11 comprises an image data storing section 12, an image processing section 13, an algorithm storing section 14, a specifying section 15, an algorithm selecting section 16, an abnormal shadow candidate detecting section 17, a detection performance inspecting section 18, a data storing section 19, an image output controlling section 20, a data outputting section 21, a display section 22 and the like. Further, in the present embodiments, the diagnosis aid apparatus 10 and the image data inputting section will be explained as example of case where they are constituted in other machine, however, the diagnosis aid apparatus 10 may be configuration having the image data inputting section 11.

The image data inputting section 11 is, for example, a laser digitizer and the like, and inputs a medical image as digital image data to the diagnosis aid apparatus 10 by scanning film in which a medical image is generated by photographing a patient, measuring transmitted light volume and analog-digital-converting the measured volume.

Further, the image data inputting section 11 is not limited to the above-described laser digitizer, and by applying light-detecting device such as CCD (Charge Coupled Device) and light-scanning on film where the medical image data is recorded and photoelectric-converting the specula light with CCD, the image data inputting section 11 may input the digital image data.

Further, the image data inputting section 11 has configuration being connectable with photographing apparatus which generates the medical image data by not reading the medical image recorded on the film but digital-converting the medical image photographed by use of an accumulative phosphor, and may input the digital image data from this radiographing apparatus to the diagnosis aid apparatus 10. In this case, film is unnecessary, and therefore it is possible to reduce cost.

Further, the image data inputting section 11 is connectable with Flat Panel Detector (Hereinafter referred to as a FPD) taking a radiation image and outputting as an electric signal, and the digital image data may be input from this FPD. In FPD, as described in JP-Tokukai-Hei 6-342098A, a radiation-detecting device generating an electric charge according to intensity of irradiated radiation and a condenser accumulating the electric charge generated by this radiation-detecting device are arranged two-dimensionally.

Further, the image data inputting section 11, as described in JP-Tokukai-Hei 9-90048A, has configuration comprising photodetectors where light-detecting device such as photodiode detecting intensity of the fluorescence, CCD, CMOS (Complementary Metal-Oxide Semiconductor) sensors are provided in each pixel, and may cause fluorescence to generate by causing radiation to absorb in a phosphor layer such as intensifying screen, and may detect the intensity of fluorescence by photodetectors, and may input the digital medical image data by photoelectric-converting. Further, the image data inputting section 11 may have configuration which combines a radiation scintillators emitting visible light in response to irradiation and area sensors corresponding to lens array and each lens.

Further, the image data inputting section 11 may input an ultrasound image photographed by the ultrasound system described in “CAD in breast cancer” (NIPPON ACTA RADIOLOGIC A 2002;62:409-414) as the medical image data. In addition, while mammography is suitable for detecting microcalcification clusters, it is said that an ultrasound image with high resolution of organ is suitable for figuring out a size and width of mass shadow.

Further, the image data inputting section 11 may have configuration for being capable of reading the medical image data from various types of storage media such as CD-ROM (Compact Disk-Read Only Memory) and floppy disk (registered trademark) storing photographed medical image data, or for being capable of receiving from an outer apparatus through network.

Further, when the digital medical image data is obtained by the above-described various configurations, though depending on a photographed part, for example, in case of mammogram, execute pixel size of image is preferably not more than 200 μm, moreover preferably not more than 100 μm. In order to demonstrate performance of the diagnosis aid apparatus 10, for example, it is preferable to input medical image data with the execute pixel size of approximately 50 μm.

A header area is provided in the medical image data input by the image data inputting section 11, and in this area, information of examination such as information regarding the medical image, for example, name of patient photographed, patient ID (ID for identifying a patient individually), patient information such as sex, photographed part, radiographic information such as radiography date, examination ID showing to which examination an image belongs (ID for identifying an examination individually) are recorded.

Further, the image data storing section 12 is composed by magnetic or optical storage medium or semiconductor memory and the like, and stores the medical image data input by the image data inputting section 11. At this time, the image data storing section 12 carries out data compression according to need. As a method of the data compression, it is possible to perform lossless or lossy compression using well-known JPEG, DPCM, wavelet transform compression and the like, however, preferably, lossless compression having no deterioration of the image data with the data compression.

The image processing section 13 applies a variety of image processing to the medical image input by the image data storing section 12 and outputs to the image output controlling section 20. Various kinds of the image processing include gradation processing which adjusts an image contrast, a contrast correction processing, a frequency emphasis processing which adjusts a degree of clearness of the image, a dynamic range compression processing for storing the image with a large dynamic range in clear concentration range without decreasing a contrast of subject's details, and the like.

In the algorithm storing section 14, for example, hard disk drive is used, and a plurality of algorithms for the detection of the abnormal shadow candidate are stored. The specifying section 15 specifies the algorithm used for the abnormal shadow candidate detection processing, and inputs and specifies patient's case information. In addition, when new operation and re-operation are input, the method of inputting directly from a keyboard and the method of selecting suitably by mouse and the like from algorithm kind and external parameter value displayed on the display section are available.

The algorithm selecting section 16 selects algorithm specified by the specifying section 15, or selects optimal algorithm on the basis of patient's case information input by the specifying section 15 and reads out selected algorithm from the algorithm storing section 14, and outputs to the abnormal shadow candidate detecting section 17. Here, it is preferable that the algorithm selecting section 16 selects the plurality of algorithms in order to detect the optimal abnormal shadow candidate according to kind of the abnormal shadow. Further, when each combination of algorithm and external parameter applied in the past is stored in the data storing section, the algorithm selecting section 16 selects the algorithm and the external parameter, and causes the algorithm and the external parameter to output to the abnormal shadow candidate.

The abnormal shadow candidate detecting section 17 performs the abnormal shadow candidate detection processing of image data derived from the image data storing section 12 according to one or the plurality of algorithms given by the algorithm selecting section 16 by using the set-up external parameter if the external parameter is set up by the specifying section 15, and obtains abnormal shadow candidate data.

Further, the abnormal shadow candidate detecting section 17 acquires an amount of characteristic corresponding to the algorithm and the external parameter from the data storing section when each combination of the algorithm and the external parameter applied in the past is stored in the data storing section, and performs detection of the abnormal shadow candidate. Therefore, the detection of the abnormal shadow candidate can be performed effectively without redundantly performing operation performed in the past.

Here, the algorithm applied when the abnormal shadow candidate by the abnormal shadow candidate detecting section 17 is detected will be explained in details. A mammography detects shadow which is regarded as feature of breast cancer, or mass and microcalcification cluster. Mass shadow is a mass with a certain size and it appears as shadow which is whitish circular shadow being close to Gaussian distribution on mammography. The microcalcification cluster has feature that when micro calcium aggregates (cluster) and is present, the corresponding part has a high possibility of having initial cancer. On the mammography it appears as whitish circular shadow having appropriately circular conic structure.

Consequently, in the abnormal shadow candidate detecting section 17, it is possible to apply a well-known method described in following paper as the above described detection algorithm of the mass shadow.
(1) A detection method by comparing left and right mammas (Med. Phys., Vol.21.No.3, pp.445-452)
(2) A detection method by using Iris filter (IEICE transactions (D-11), Vol.J75-D-11, no.3, pp.663-670, 1992)
(3) A detection method by using Quoit filter (IEICE transactions (D-11), Vol.J76-D-11, no.3, pp.279-287, 1993)
(4) A detection method with binarization based on histogram of pixel values of divided mamma areas (Jamit Frontier lecture collected paper, pp.84-85, 1995)
(5) A minimum direction differential filter picking up minimum output from a large number of Laplacian filter having polarity (IEICE transactions (D-11), Vol.J76-D-11, no.2, pp.241-249, 1993)

Further, as the detection algorithm of a shadow of microcalcification clusters, it is possible to apply well-known detection methods described in the following paper.
(1) A detection method by using an image on which Laplacian filter processing is applied (IEICE transactions (D-11), Vol.J71-D-11, no.10, pp.1994-2001, 1988)
(2) A detection method using a morphologically analyzed image in order to inhibit a background pattern such as mammary gland or the like (IEICE transactions (D-11), Vol.J71-D-11, no.7, pp.1170-1176, 1992)

Further, the detection performance inspecting section 18 inspects the detection performance in each condition of the detection based on the detection result of the abnormal shadow candidate detected in the past. Specifically, the detection performance inspecting section 18 obtains the detection result of the abnormal shadow candidate detected by combination of the plurality of algorithms and external parameters from the data storing section for one medical image. Further, the detected abnormal shadow candidate in each detecting condition in which at least one of algorithm and external parameter is different from each other, are judged whether they are TP or FP, with respect to the confirmed diagnostic results thereof.

Further, the detection performance inspecting section 18 judges the authenticity of the detected abnormal shadow candidate, that is, whether the detected abnormal shadow candidate is true positive or false positive, and calculates statistics information of the determined result. For example, a True Positive (TP) and a False Positive (FP) for the abnormal shadow candidate are calculated for each detection condition of the abnormal shadow candidate. Here, the calculated True Positive (TP) is, for example, one which is calculated in each cancerous region, and is shown in the following formula (1).
TP=number of the detected abnormal shadow candidate/number of cancerous region (1)

Further, the False Positive (FP) is one which is calculated for each medical image, and is shown in the following formula (2).
FP=number of normal region detected as abnormal shadow candidate/number of images (2)

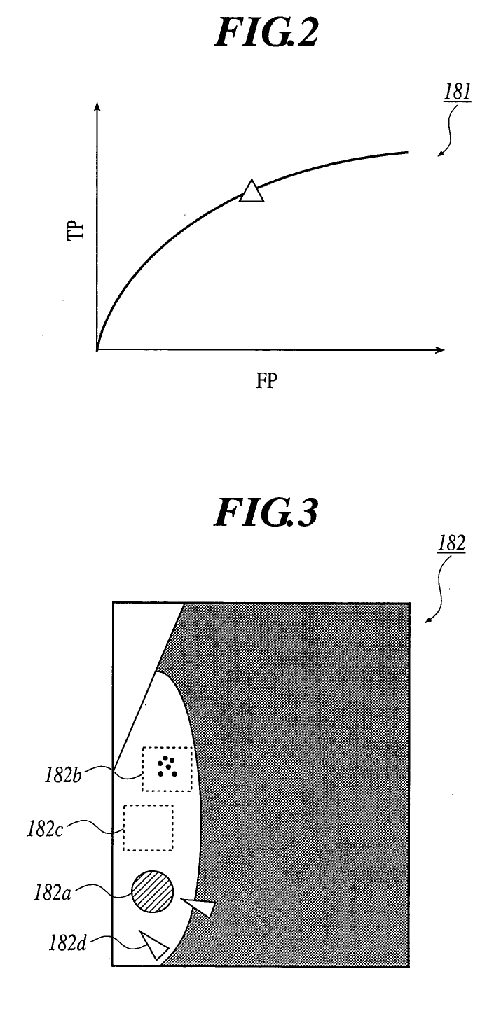

Further, the detection performance inspecting section 18, based on the True Positive (TP) and the False Positive (FP) calculated, creates graph showing the detection performance of the abnormal shadow candidate in each algorithm, and outputs to the data outputting section 21. TP-FP graph 181 will be explained with reference to FIG. 2. The TP-FP graph 181 in which TP is set in vertical axis and FP is set in horizontal axis, is graph that generally FP rises with TP rising. Thus, when a rate of detection is improved, the rate of detection for primary lesion is improved, while it is a relation of trade-off that the rate of detection for the false positive becomes high and a rate of error rises.

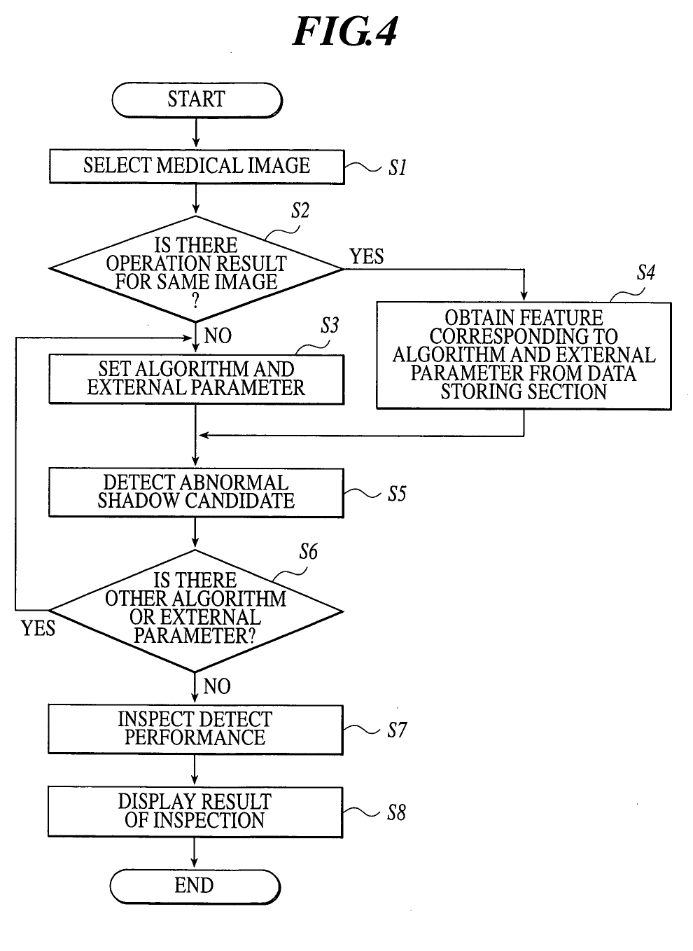

Further, the detection performance inspecting section 18, based on the True Positive (TP) and the False Positive (FP), creates a image data of simulated abnormal shadow candidate, and outputs this as simulation image to the data outputting section 21. The simulation image will be explained with reference to FIG. 3. As shown in FIG. 3, in simulation image 182, a number and a location are shown qualitatively with mass shadow 182a and 182d indicated by triangular sign and microcalcification cluster 182b and 182c indicated by dashed frame. Among them, it is shown that mass shadow 182a shown by circle part of slash is true positive, and mass shadow 182d with no circle part of slash is false positive. Further, it is shown that microcalcification cluster 182b shown by a set of minute point is true positive, and microcalcification cluster 182c with no a set of minute point is false positive. In example of FIG. 3, since a setup which gives priority to the rate of detection is carried out, it is typically shown that a false lesion is detected while the primary lesion is detected.

In the data storing section 19, for example, hard disk device is used, the detection result of the abnormal shadow candidate detected by the abnormal shadow candidate detecting section 17 is stored. Further, the data storing section 19 stores the detection result so as to relate the algorithm and the external parameter in case where the external parameter is used for the applied algorithm when detecting the abnormal shadow candidate and the detected detection result of the abnormal shadow candidate. Further, the data storing section 19 stores the result of inspection for the detection performance corresponding to diagnostic result such as the detection result of the abnormal shadow candidate, the detection condition of the abnormal shadow candidate, the diagnostic result for interpretation of medical image, the pathological diagnostic result, the confirmed diagnostic result based on the diagnostic result for interpretation of medical image and/or the pathological diagnostic result.

Further, the data storing section 19 stores the determined result of authenticity of the abnormal shadow candidate determined based on the detection result and the diagnostic result of the abnormal shadow candidate corresponding to the medical image, the algorithm, and the external parameter. In addition, the data storing section 19 may be configuration storing the detection result and the detection performance of the abnormal shadow candidate with the patient information and the examination information.

The image output controlling section 20 controls when the medical image is output on the display section 22. When the medical image input from the image processing section 13 is output on the display section 22, the image output controlling section 20 reads out information of the abnormal shadow candidate stored in an abnormal shadow candidate storing section (not shown). And based on this information of the abnormal shadow candidate, the image output controlling section 20 outputs image area of the abnormal shadow candidate so as to be identifiable by marking the image area of the abnormal shadow candidate in the medical image data by arrow and changing a color of the image area of the abnormal shadow candidate in the medical image data and the like.

The doctor for Interpretation of medical image causes a graph of True Positive (TP) and False Positive (FP) (hereinafter, referred to as TP-FP graph) created by the detection performance inspecting section 18 through the data outputting section 21 to display on the display section 22 when knowing a performance of CAD used and adjusting the detection performance of CAD. Further, the data outputting section 21 causes simulation image instead of TP-FP graph to display on display section 22 as one example of result of inspection for the detection performance of the abnormal shadow candidate. In addition, the detailed examples of the medical image displaying screen where TP-FP graph or simulation image is displayed by the data outputting section 21 will be described later.

Further, since an operating time is required for the detection of the abnormal shadow candidate except diverting operation result stored in the past, the data outputting section 21 causes progress about the detection of the abnormal shadow candidate to display on the display section 22 while the abnormal shadow candidate is detected by the abnormal shadow candidate detecting section 17. This makes it possible to check progress when CAD is performed for a number of image (data) such as CT·MRI image, and to eliminate useless waiting time of doctor for interpretation of medical image.

In the display section 22, the display section comprising CRT (Cathode Ray Tube), LCD (Liquid Crystal Display) and plasma display and the like are applied, and carry out display-output the medical image data output from the image output controlling section 20, the progress input from the data outputting section, and the results of inspection for the detection performance of abnormal shadow candidate. As display section, CRT and LCD with fineness high luminance only for medical image are preferable.

Further, in the diagnosis aid apparatus 10, a printer recording on recording medium such as a paper and an exposure device recording on film, and the like may be provided and a configuration print-outputting and exposure-outputting information regarding the medical image and/or the detection performance by these outputting section may be used as well.

Next, operation of the embodiment will be explained.

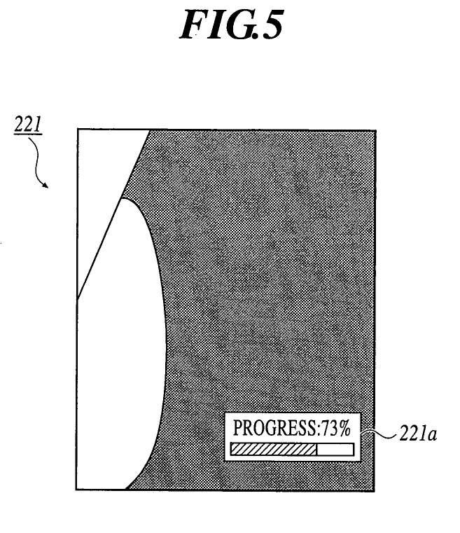

FIG. 4 is flow chart which shows abnormal shadow candidate detection processing performed by the diagnosis aid apparatus 10. This abnormal shadow candidate detection processing is processing which performs detection processing of the abnormal shadow candidate by applying the plurality of algorithms or external parameters selected, and compares the detected detection results of the abnormal shadow candidate with the diagnostic result such as the confirmed diagnostic results including the diagnostic results and the pathological diagnostic results by the doctor for interpretation of medical image, and inspects the detection performance of the abnormal shadow candidate, and displays the results of inspection.

First, as shown in FIG. 4, the medical image data is input by the image data inputting section 11 and the aforementioned input medical image data is stored in the image data storing section 12. Further, the medical image stored in the image data storing section 12 is selected as medical image data to which the detection of abnormal shadow candidate is performed by being output to the abnormal shadow candidate detecting section 17 according to instruction input by the specifying section 15 (step S1).

Next, it is determined by the abnormal shadow candidate detecting section 17 whether or not the algorithm and the external parameter operated about a selected medical image in the past are stored in data storing section (step S2). When the algorithm and the external parameter operated in the past are stored in the data storing section (step S2; YES), feature corresponding to the algorithm and the external parameter is obtained (step S4). And, the detection processing of the abnormal shadow candidate is preformed from medical image based on the obtained feature by the abnormal shadow candidate detecting section 17 (step S5).

On the contrary, when the algorithm and the external parameter operated in the past are not stored in the data storing section (step S2; NO), the algorithm and the external parameter are selected by the specifying section 15 and the algorithm selecting section 16, in the abnormal shadow candidate detecting section 17, the selected algorithm and external parameter are set (step S3). Here, it is preferable that the algorithm and the external parameter are multiple-selected.

Further, by the abnormal shadow candidate detecting section 17, the set algorithm and external parameter are applied, and the detection processing of the abnormal shadow candidate is preformed from the medical image data (step S5). Further, the applied algorithm and external parameter are stored as detection condition corresponding to the abnormal shadow candidate detected from the medical image data in the data storing section 19

Further, it is determined by the algorithm selecting section 16 whether or not combination of other algorithm and other external parameter is selected (step S6). Thus, the abnormal shadow candidate detecting section applies the multiple-selected algorithm and external parameter, and based on combination pattern of medical image×algorithm×external parameter, the detection processing of the abnormal shadow candidate is preformed multiple times. Accordingly, The possible combination pattern of the multiple-selected algorithm and external parameter is selected, and it is determined whether or not there is combination pattern in which the detection of the abnormal shadow candidate is not performed.

Further, when the combination of other algorithm or external parameter in which the detection of the abnormal shadow candidate is not performed is selected (step S6 YES), it shifts to step S3, the algorithm and the external parameter selected newly is applied, and the detection processing of the abnormal shadow candidate is preformed.

Subsequently, when the detection processing of the abnormal shadow candidate is completed (step S6; NO), the detection results of the abnormal shadow candidate in each algorithm and external parameter are obtained from the data storing section 19 the detection performance inspecting section 18. Subsequently, based on the obtained detection result and the confirmed diagnostic result of the abnormal shadow candidate, the inspection of the detection performance is preformed, and consequently the TP-FP graph or the simulation image is created (step S7). Further, while the medical image data is output on the display section 22 by the image output controlling section 20, the result of the inspection for the detection performance is output on the display section 22 (step S8).

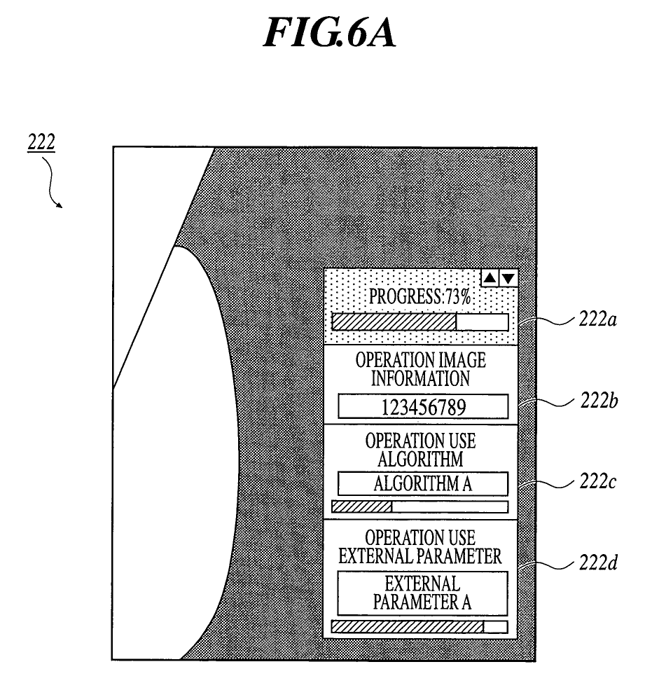

Next, in the above described the detection processing of the abnormal shadow candidate, the display screen for medial image displayed on the display section 22 will be explained. FIG. 5 is a view showing one example of the display screen for medical image displayed on the display section 22 while the detection processing of the abnormal shadow candidate is performed. As shown in FIG. 5, in the display screen for medical image 221 region where the medical image data is displayed is provided, and region where a progress is displayed is provided in a region where a subject does not exist in medical image data. Here, the progress displayed on the display section 22 is displayed while the detection processing of the abnormal shadow candidate is performed by the abnormal shadow candidate detecting section 17, as an example, the progress of the detection processing of the abnormal shadow candidate for the medical image data photographed about one patient is displayed.

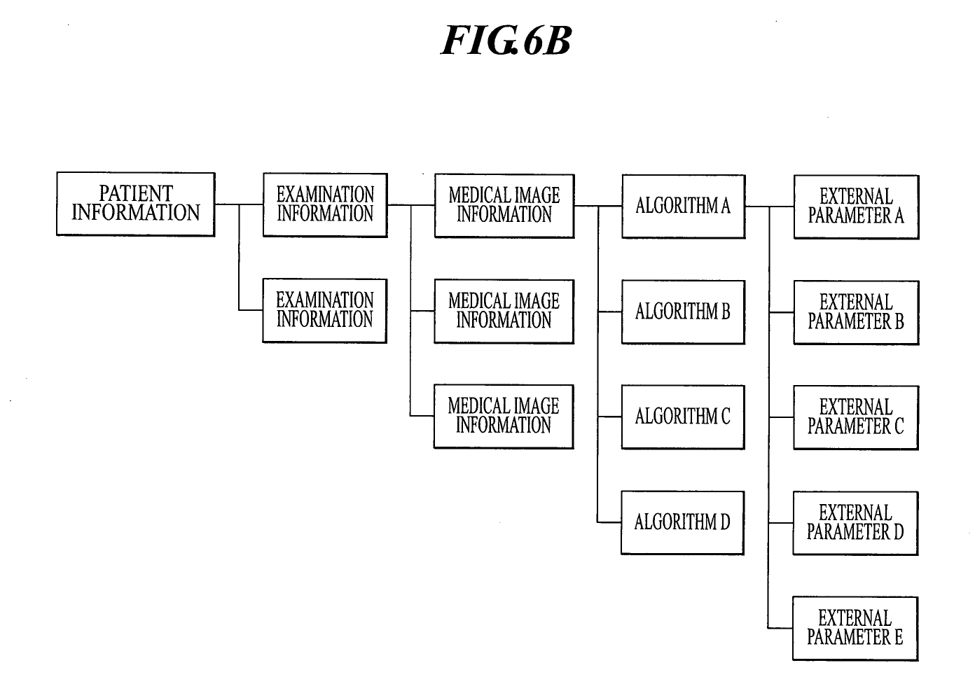

Further, the progress displayed on the display section 22 may be configuration displayed based on a variety of information. For example, as information regarding the medical image given to one patient, patient information, examination information, medical image information, algorithm, external parameter and the like are included. Specifically, it is shown that the information shown in FIG. 6B includes two kinds of examination information for one patient, each examination information includes three kinds of medical image information, four kinds of algorithms are set in each medical image information, five kinds of external parameters are set in each algorithm. When the detection processing of the abnormal shadow candidate is performed about this patient, the example where the progress is displayed on the basis of these information will be explained. In addition, the data configuration of information shown in FIG. 6B shows only data which belongs to the upper data however, data corresponding to each is set also about examination information, medical image information, and algorithm information described in the second or less step.

FIG. 6A is view showing one example of a display screen for medical image when the progress is displayed based on a plurality of pieces of information. As shown in FIG. 6A. on the display screen for medical image 222, the medical image data is displayed, and the region where progress is displayed on the region where a subject does not exist of medical image data is provided. Here, as progress, the progress about three kinds of information is displayed, in region 222a described on the top, the progress of the detection processing of the abnormal shadow candidate for one patient is shown as “73%”. Further, in region 222b described on the second step, identification information of medical image in which the detection processing is performed is shown as the medical image information, and it is shown that the detection processing of the abnormal shadow candidate is performed for the medical image of Code No.123456789 among a plurality of medical image data about one patient.

In region 222c described on the third step, the progress about algorithm is shown, algorithm name applied to the detection processing at present is displayed as “ALGORITHM A”, the progress for operation of ALGORITHM A is displayed by indicator. In region 222d described on the fourth step, the progress about the external parameter is displayed, external parameter name applied to the operation at present is displayed as “EXTERNAL PARAMETER B”, the progress for the operation of EXTERNAL PARAMETER B is displayed by indicator.

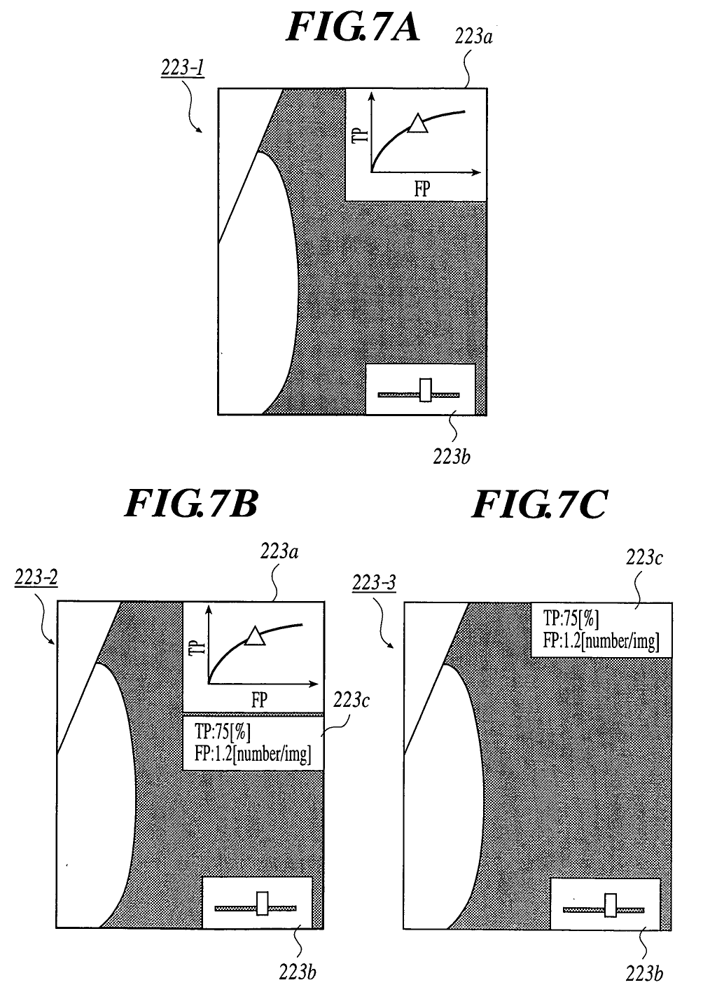

FIG. 7A to 7C are views showing one example of the display screen for medical image when the result of inspection for the detection performance output from the detection performance inspecting section 18 is displayed. As shown in FIG. 7A, on the display screen for medical image 223-1, the medical image data is displayed, in the region where a subject dose not exist of the medical image data, a region 223a which displays TP-FP graph which is the result of inspection for the detection performance and a region 223b which displays a slide bar which changes a rate of TP-FP on the TP-FP graph are provided. By operating this slide bar right and left by the specifying section 15, A marker on the TP-FP graph can be changed according to any rate of TP-FP.

Accordingly, doctor can grasp exactly the detection performance for the abnormal shadow candidate on the basis of this TP-FP graph. Thereby, the optimal detection performance of the abnormal shadow candidate according to doctor's skill by regarding the TP-FP graph as index. Further, the display screen for medical image 223-1 may be configuration displaying value of the True Positive (TP) and the False Positive (FP) as number information in point specified by the slide bar. Specifically, as shown in FIG. 7B, display screen for medical image 223-2 displays the number information of TP, FP as “TP: 75[%] FP: 1.2 [number/img] ” while the TP-FP graph is displayed. Alternatively, as shown in FIG. 7C, display screen for medical image 223-3 may be configuration displaying only the number information of TP, FP without displaying the TP-FP graph. It is assumed that these display screens for medical image are displayed according to user setting so as to be changeable.

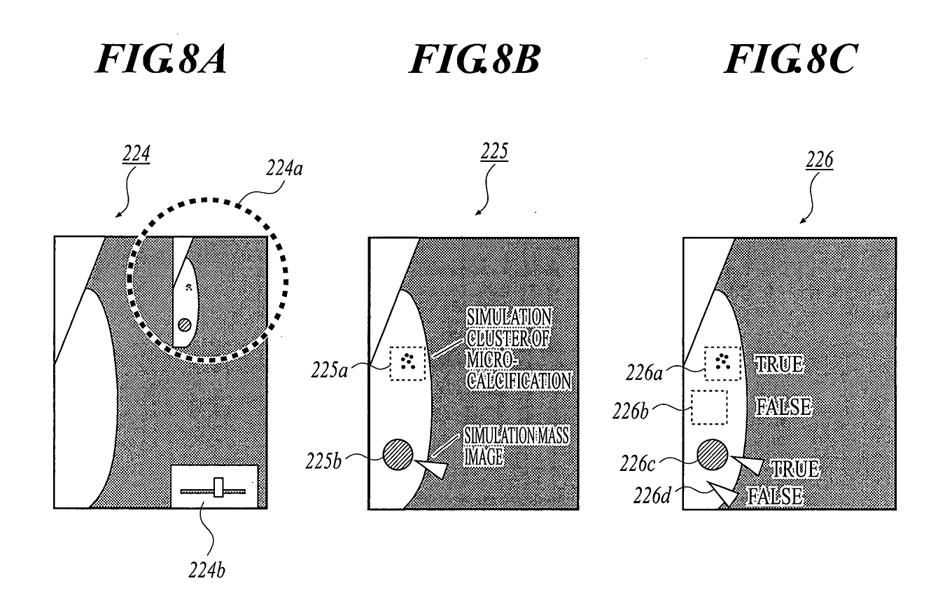

FIG. 8A is a view showing one example of the display screen for medical image when the result of inspection for the detection performance output by the detection performance inspecting section 18 is displayed on other mode. As shown in FIG. 8A, on a display screen for medical image 224, the medical image data is displayed, in the region where a subject dose not exist of the medical image, a region 224a displaying the simulation image which is the result if inspection for the detection performance and a region 224b displaying the slide bar which changes a rate of TP-FP in the TP-FP graph of the simulation image are provided. By operating this slide bar right and left by the specifying section 15, simulation image can be displayed according to the rate of TP-FP.

For example, the drawing shown in FIG. 8B is enlarged view showing one example of simulation image displayed when the slide bar is moved to left and the rate of TP˜FP is lowered, or detection rate of the abnormal shadow candidate is lowered. As shown in FIG. 8B, in simulation image 225, simulation cluster of micro-calcification 225a and simulation mass image 225b are shown as the simulation image. Thus, as a result of decreasing the detection performance, result that only a true positive abnormal shadow candidate is detected is displayed although the detection rate of the abnormal shadow candidate is lowered.

Further, the view shown in FIG. 8C is enlarged view showing one example of simulation image displayed when the slide bar is moved to right and the rate of TP-FP is raised, or the detection rate of the abnormal shadow candidate is raised. As shown in FIG. 8C, in simulation image 226, true simulation calcification image 226a, false simulation calcification image 226b, true simulation mass image 226c, and true simulation mass image 226d are shown as simulation image. Thus, the result that as a result of improving the detection performance, the detection rate of the abnormal shadow candidate is raised, and consequently, not only true positive but also false positive of the abnormal shadow candidate is detected is shown. In addition, the simulation image 226 is one example, and for example, may be configuration which indicates “true”, and “false” by triangle mark for all abnormal shadow candidate.

As described above, by changing the rate of TP-FP, it is possible to cause the detected abnormal shadow candidate to display as simulation image, and to confirm rough detection performance of the abnormal shadow candidate which is hard to be grasped only using value by image. Therefore, doctor can adjust optimal detection performance of the abnormal shadow candidate by regarding the displayed simulation image as index when adjusting the detection performance of the abnormal shadow candidate.

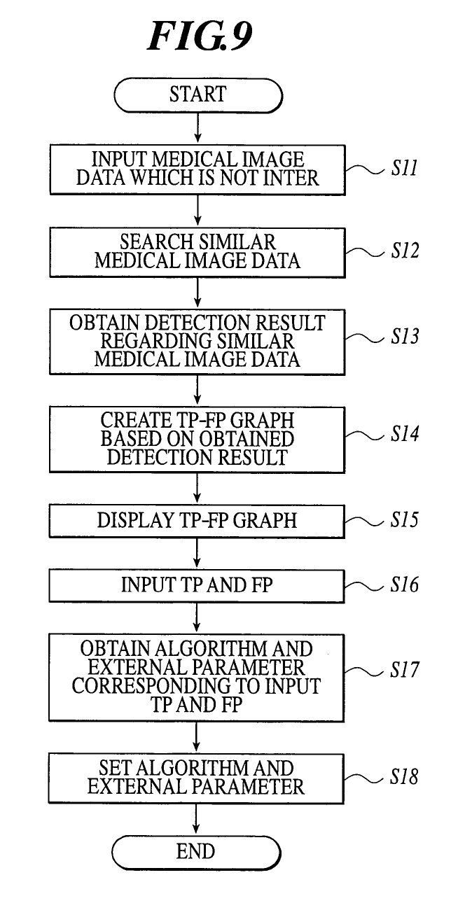

Further, based on the result of inspection for the detection performance output from the detection performance inspecting section 18, the diagnosis aid apparatus 10 obtains the algorithm and the external parameter corresponding to TP-FP specified by the specifying section 15 from the data storing section 19 and performs an adjustment processing for the detection performance which determines combination of an optimal detection condition. FIG. 9 is a flowchart showing the adjustment processing for the detection performance performed by the diagnosis aid apparatus 10.

As shown in FIG. 9, when the medical image data which is not interpreted is input by the image data inputting section 11 (step S11), the medical image data similar to the input medical image data is searched from database (hereinafter, referred to as a DB) which is not illustrated (step S12). Here, as for the medical image stored in the DB, the detection result of the detection processing for the abnormal shadow candidate using the plurality of combinations of algorithms and external parameters or the plurality of combinations of one algorithm and external parameters or the plurality of combinations of algorithms and one external parameter and the result of inspection of the detection performance inspecting by the detection performance inspecting section 18 are stored in the data storing section.

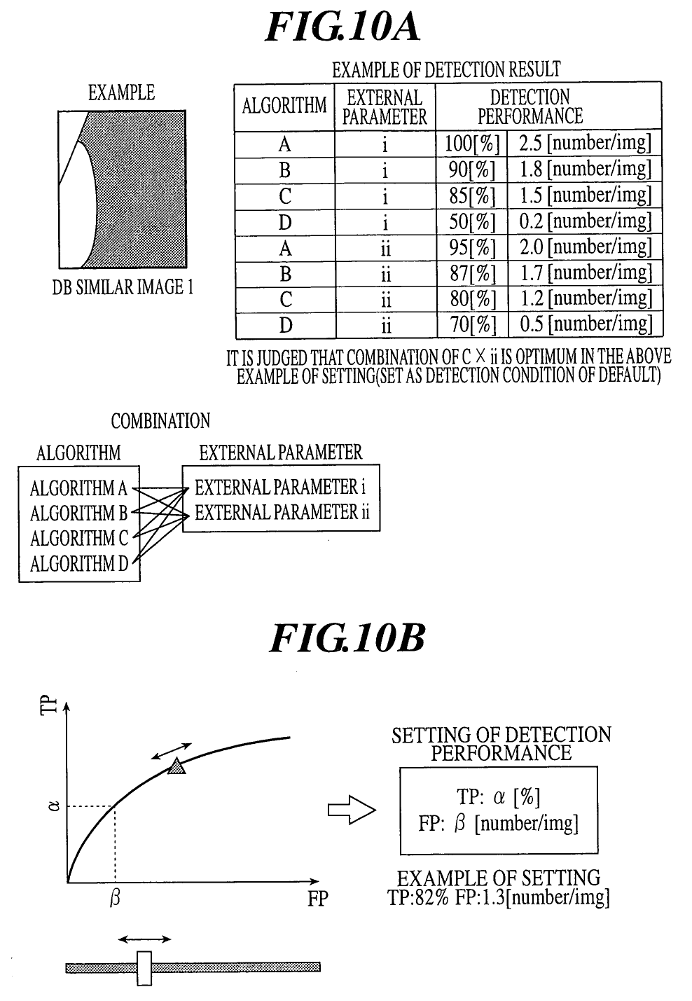

Next, by the detection performance inspecting section 18, the result of inspection for the detection performance about similar medical image data is obtained from the data storing section 19 (step S13), and based on the obtained result of inspection for the detection performance, the TP-FP graph is created (step S14). With reference to FIG. 10, the result of inspection for the detection performance stored in the data storing section 19 will be explained.

FIG. 10A is a view for explaining the result of inspection for the detection performance obtained when the detection processing of the abnormal shadow candidate is performed for similar medical image data using the plurality of combinations of algorithms and external parameters or the plurality of combinations of one algorithm and external parameters or the plurality of combinations of algorithms and one external parameter. As shown in the left side of FIG. 10A, for the medical image stored in DB, when combining algorithm A to D and external parameter i to ii respectively and performing the detection processing of the abnormal shadow candidate, the detection results obtained from combination of algorithm and external parameter are 8 sets.

Subsequently, by applying 8 sets of combination of these algorithms and external parameters, the detection processing of the abnormal shadow candidate is performed for the medical image data. Further, based on each detection result, by performing inspection for the detection performance the obtained result of inspection will be shown in a right table of FIG. 10A. In this table, the True Positive (TP) and the False Positive (FP) for every 8 sets of combination of the algorithm and the external parameter are shown as the result of inspection. In addition, when adjusting the detection performance, in case that arbitrary FP and TP are specified, the combination of the algorithm and the external parameter corresponding to the specified TP and FP are obtained on the basis of this table.

When it returns to step S13 of FIG. 9, and the result of inspection for the detection performance is obtained from the data storing section 19 by the detection performance inspecting section 18, based on the obtained the result of inspection, the TP-FP graph is created (step S14). Further, the created TP-FP graph is displayed on the display section 22 (step S15). FIG. 10B is a view showing example of display image of the TP-FP graph displayed on the display section 22.

With reference to The TP-FP graph displayed on this display section 22, the slide bar displayed at the same time is manipulated by the specifying section 15 and arbitrary FT and TP are input (step S1). Further, by the abnormal shadow candidate detecting section 18, the combination of algorithm and external parameter corresponding to the input FT and TP is obtained from the data storing section (step S1).

For example, in display screen shown in FIG. 10B, when the slide bar is manipulated and TP: 82(%) and FP: 1.3 (number/img) are specified, as the combination of corresponding algorithm and external parameter, the combination algorithm C and external parameter ii where FT and TP show the nearest value is obtained. Further, the abnormal shadow candidate detecting section 18 sets the obtained algorithm and external parameter as detection condition of the abnormal shadow candidate (step S18), and the detection performance adjusting processing is completed.

As described above, according to the embodiments, the diagnosis aid apparatus 10 performs the detection of the abnormal shadow candidate by applying the plurality of combinations of algorithms and external parameters or the plurality of combinations of one algorithm and external parameters or the plurality of combinations of algorithms and one external parameter, and the detection performance for the abnormal shadow candidate is calculated as the True Positive (TP) and the False Positive (FP) according to combination pattern of each algorithm and external parameter. Further, based on the calculated the True Positive (TP) and the False Positive (FP) of the abnormal shadow candidate, the diagnosis aid apparatus 10 creates the TP-FP graph or the simulation image and causes them to display as result of inspection for the detection performance of the abnormal shadow candidate on the display section 22 and consequently, causes them to use as index when adjusting the detection performance of the abnormal shadow candidate.

Therefore, in case the medical image is output, when performing adjustment of the optimal algorithm or external parameter, since the result of inspection for the detection performance is displayed on the display section 22 and based on the aforementioned result of inspection, the combination of suitable algorithm or external parameter is selected, and consequently the adjustment for the detection performance of the abnormal shadow candidate can be performed. Therefore, since the detection processing of the abnormal shadow candidate is performed by adjusting the detection performance according to doctor's skill and level of proficiency, it becomes possible to increase level of the interpretation of medical image and to improve diagnostic efficiency.

Further, as information showing the detection performance of the abnormal shadow candidate, in addition to showing quantitatively by the TP-FP graph and/or the value of TP and FP, it is possible to show the rough detection performance by the simulation image, and doctor can visually grasp and adjust the detection performance of the abnormal shadow candidate. Therefore, according to doctor's skill and preference, based on TP-FP graph, the adjustment of the detection performance of the abnormal shadow candidate can be performed exactly, and further, based on the simulation image, the adjustment of the detection performance of the abnormal shadow candidate can be performed sensuously.

Further, the abnormal shadow candidate detecting section 17 can obtain the detection result of the abnormal shadow candidate based on each algorithm, external parameter, and combination thereof in details in order to preform the detection performance of the abnormal shadow candidate multiple times with the plurality of algorithms, external parameters, and combination thereof. Accordingly, since it is possible to process the detection performance of the abnormal shadow candidate statistically based on the detection result obtained in details, and to inspect the detection performance of the abnormal shadow candidate based on statistical result, the exact detection performance of the abnormal shadow candidate can be obtained.

Further, since the data storing section causes the medical image and the detection results of the abnormal shadow candidate about the aforementioned medical image, and the applied algorithm and external parameter when detecting the abnormal shadow candidate to respectively store correspondingly, it is possible to utilize effectively the detection results of the abnormal shadow candidate performed in past, and to inspect the detection performance of the abnormal shadow candidate.

Further, since the medical image used to inspect the detection performance is one which accompany with the diagnosis results by a doctor for interpretation of medical image and the confirmed diagnostic results based on the pathological diagnostic result, it is possible to determinate definitely whether lesion detected as abnormal shadow candidate is true positive or false positive. Therefore, the detection performance inspecting section 18 can judge whether the abnormal shadow candidate detected by a variety of algorithm and external parameter and combination thereof is true positive or false positive and can perform statistical operation exactly and promptly and can obtain result of inspection.

Further, in order to judge for every detection condition whether the abnormal shadow candidate detected by a variety of algorithm and external parameter and combination thereof is true positive or false positive and to perform statistical operation thereof, when adjusting the detection performance of the abnormal shadow candidate, the adjusting of detection performance can be performed based on detailed algorithm and external parameter and combination thereof.

As described above, according to the embodiments, it is possible to cause the result of inspection about the detection performance of the abnormal shadow candidate to display as index, and to cause the suitable algorithm and external parameter to set based on the result of inspection about the detection performance displayed, and to adjust the detection performance of the abnormal shadow candidate easily and accurately according to doctor's skill. Consequently, it becomes possible to raise level for interpretation of medical image and to improve efficiency of diagnosis.

In addition, the description in the above described embodiment of the invention is one suitable example for the diagnosis aid apparatus of the invention, and is not limited to the example.

For example, in the embodiments, Explanation was given by considering the case where the detection performance of the abnormal shadow candidate is displayed as the TP-FP graph or the simulation image as example and but is not limited, for example, the detection performance of the abnormal shadow candidate may be configuration displaying on the display section 22 by considering True Positive and False Positive calculated by the detection performance inspecting section as numerical information

Further, example of algorithm listed in the embodiments is one example and it is assumed that the detection performance of the abnormal shadow candidate is possible based on other various algorithms.

As for forth, regarding detail configuration and detail behavior of configuration part of the diagnosis aid apparatus 10 in the present embodiment, it is possible that various changes may be made without departing from the gist of the invention.

The entire disclosure of Japanese Patent Application No. Tokugan 2003-298792 filed on Aug. 22, 2003 including a specification, claims, drawings, and summaries are incorporated herein by reference in their entirety.

1. A diagnosis aid apparatus comprising:
a display section for displaying a medical image of a photographed subject;
an abnormal shadow candidate detecting section for detecting an abnormal shadow candidate from the medical image based on a detection condition;
a detection performance inspecting section for inspecting a detection performance in each detection condition of the abnormal shadow candidate by comparing a detection result of the abnormal shadow candidate detected by the abnormal shadow candidate detecting section with accompanying information of the medical image;
a data outputting section for displaying the detection performance of the abnormal shadow candidate, which is inspected by the detection performance inspecting section, on the display section.

2. The apparatus of claim 1, further comprising a specifying section for specifying a plurality of medical images in which the abnormal shadow candidate detecting section detects the abnormal shadow candidate.

3. The apparatus of claim 1, wherein the abnormal shadow candidate detecting section sets up at least two or more selected among a plurality of combinations of algorithms and external parameters or among a plurality of combinations of one algorithm and external parameters or among a plurality of combinations of algorithms and one external parameter as the detection condition of the abnormal shadow candidate, and
the apparatus further comprises a data storing section for storing the algorithm and the external parameter set up by the abnormal shadow candidate detecting section so as to relate the algorithm and the external parameter to the medical image.

4. The apparatus of claim 3, wherein the abnormal shadow candidate detecting section applies the at least two or more of set up selected among the plurality of combinations of algorithms and external parameters or among the plurality of combinations of one algorithm and external parameters or among the plurality of combinations of algorithms and one external parameter among the algorithms or external parameters, based on pattern of the plurality of combinations of algorithms and external parameters or the plurality of combinations of one algorithm and external parameters or the plurality of combinations of algorithms and one external parameter, and detects the abnormal shadow candidate from the medical image; and
the data storing section stores the detection result of the abnormal shadow candidate detected by the abnormal shadow candidate detecting section so as to relate the detection result of the abnormal shadow candidate detected by the abnormal shadow candidate detecting section to the algorithms and the external parameters being the detection condition.

5. The apparatus of claim 1, further comprising a data outputting section for displaying progress in a detection of the abnormal shadow candidate on the display section while the detection of the abnormal shadow candidate is performed by the abnormal shadow candidate detecting section.

6. The apparatus of claim 5, wherein the data outputting section displays at least one or more of patient information, information of examination, medical image information, the algorithm and the external parameter about the medical image in which the detection of the abnormal shadow candidate is performed, when the progress is displayed on the display section.

7. The apparatus of claim 3, wherein the data storing section stores at least one of a diagnostic result, a pathological diagnostic result and a confirmed diagnostic result by a doctor for an interpretation of a medical image as the accompanying information of the medical image so as to relate the medical image.

8. The apparatus of claim 1, wherein the medical image includes at least one of the diagnostic result, the pathological diagnostic result and the confirmed diagnostic result by a doctor for a interpretation of the medical image.

9. The apparatus of claim 3, wherein the detection performance inspecting section judges truth or false about the detection result in each detected abnormal shadow candidate based on the accompanying information of the medical image and the detection result of the abnormal shadow candidate, and
the data storing section stores a judged result with the medical image.

10. The apparatus of claim 9, wherein the detection performance inspecting section calculates statistics in each of the applied algorithm, the applied external parameter, or the combination of the applied algorithm and the applied external parameter as a result of inspection for the detection performance based on the judged result stored in the data storing section, and creates a graph showing a rate of truth or false about the detected abnormal shadow candidate based on the calculated statistics, and
the data outputting section displays the graph created by the detection performance inspecting section on the display section.

11. The apparatus of claim 10, wherein the data outputting section prints out at least one of numerical information about the statistics calculated as the result of the inspection, the graph and a simulation image with the medical image.

12. The apparatus of claim 9, wherein the detection performance inspecting section calculates statistics in each of the applied algorithm, the applied external parameter or the combination of the applied algorithm and the applied external parameter as a result of inspection for the detection performance based on the judged result stored in the data storing section, and creates the simulation image which shows the rate of truth or false about the detected abnormal shadow candidate, and
the data outputting section displays a simulation image created by the detection performance inspecting section on the display section.

13. The apparatus of claim 12, wherein the data outputting section prints out at least one of the numerical information about the statistics calculated as the result of the inspection, the graph and the simulation image with the medical image.

14. The apparatus of claim 1, wherein the medical image is a mammogram.

15. The apparatus of claim 1, wherein the medical image is a medical image generated by a CT apparatus or an MRI apparatus.

16. The apparatus of claim 1, wherein the medical image is a medical image generated by an ultrasound system.
